(19) United States
(12) Patent Application Publication
(10) Pub. No.: US 2025/0352992 A1
(43) Pub. Date: Nov. 20, 2025

(54) METHOD FOR MANUFACTURING EXHAUST GAS PURIFICATION CATALYST DEVICE

(71) Applicant: CATALER CORPORATION, Kakegawa-shi, Shizuoka (JP)

(72) Inventors: Yasuyoshi KURATA, Kakegawa-shi (JP); Ken ATSUMI, Kakegawa-shi (JP)

(73) Assignee: CATALER CORPORATION, Kakegawa-shi, Shizuoka (JP)

(21) Appl. No.: 18/854,655

(22) PCT Filed: Apr. 10, 2023
(86) PCT No.: PCT/JP2023/014523

§ 371 Date: Oct. 7, 2024

(30) Foreign Application Priority Data
Apr. 26, 2022 (JP) 2022-072659

(51) Int. Cl. B01J 37/02; B01D 53/94; B01J 35/57

(52) U.S. Cl. CPC B01J 37/0215; B01D 53/94; B01J 35/57; B01D 2255/9155

(57) ABSTRACT

A method for manufacturing an exhaust gas purification catalyst device, the method including: (A) disposing a substrate wherein open ends on one side of multiple cell flow paths face upward and face downward on the other side, installing a coating liquid retention tool having a retention wall at the upper-end section of the substrate, and forming a coating liquid retention part; (B) supplying a coating liquid for forming a catalyst coat layer to the retention part; (C) reducing pressure within the cell flow paths below coating liquid retention part pressure, thereby coating substrate partition walls with the coating liquid; (D) spraying the inner side of the retention wall of the coating liquid retention tool with compressed air from above; and (E) firing the substrate coated with the coating liquid for forming a catalyst coat layer, the step (C) and the step (D) being performed simultaneously.

### FIELD

The present invention relates to a method for producing an exhaust gas purification catalyst device.

### BACKGROUND

Exhaust gas emitted from an internal combustion engine such as an automobile engine is released into the air after having been purified by an exhaust gas purification catalyst device installed in an exhaust system. The exhaust gas purification catalyst device has a structure which includes, for example, a honeycomb substrate having multiple cell flow channels sectioned by partition walls, and a catalyst coating layer formed on, and/or inside, the partition walls of the honeycomb substrate.

This type of exhaust gas purification catalyst device is produced by coating a coating solution comprising the starting component for the catalyst coating layer onto the partition walls of the honeycomb substrate, and then firing it.

A known method of coating the coating solution onto the partition walls of the honeycomb substrate is by placing the coating solution on one end face of the honeycomb substrate and suctioning it from the end face on the opposite side (suction method). PTL 1, for example, describes mounting a frame shaped reservoir tool capable of storing a coating solution on a first end face of the honeycomb substrate and filling a coating solution on the first end face, and then relatively lowering the pressure at the second end face on the opposite side from the first end face, with respect to the pressure on the first end face side, to produce a flow of the coating solution from the first end face toward the second end face, and cause the coating solution to be coated onto the partition walls of the honeycomb substrate.

Incidentally, an exhaust gas purification catalyst device will sometimes have catalyst coating layers with different compositions situated at the upstream end and downstream end of the honeycomb substrate in a “zone coating” construction, in order to improve exhaust gas purification performance. A catalyst coating layer with such a zone coating construction can be produced, for example, using a suction method to form a first catalyst coating layer of a desired length from one end face of the substrate by the suction method, and then to form a first catalyst coating layer of predetermined length from the other end face of the substrate.

### CITATION LIST

### Patent Literature

[PTL 1] Japanese Unexamined Patent Publication No. 2018-015704

### SUMMARY

### Technical Problem

When coating of a coating solution onto a honeycomb substrate is carried out by a suction method, leakage of the coating solution out of the honeycomb substrate from the edge on the suction side results in waste of some of the coating solution, thus increasing production cost for the exhaust gas purification catalyst device. The increase in production cost for the exhaust gas purification catalyst device due to waste of the coating solution is especially high when the catalyst coating layer includes a noble metal catalyst, due to the high value of the coating solution.

In order to avoid such waste, the coating solutions used in suction methods are usually adjusted to a relatively high viscosity.

When a catalyst coating layer with a zone coating construction is to be formed by a suction method, the coating solution is likewise adjusted to high viscosity in order to control the catalyst coating layer to the predetermined length.

When coating a high-viscosity coating solution by a suction method, the coating solution often adheres to the inner walls of the reservoir tool mounted on the honeycomb substrate end face. Adhesion of coating solution onto the inner walls of the reservoir tool can result in an insufficient coating amount on the partition walls of the honeycomb substrate, or inability to coat the coating layer to the predetermined length, potentially causing quality defects in the exhaust gas purification catalyst device.

In addition, when any coating solution which has adhered to the inner walls of the reservoir tool falls onto the honeycomb substrate, portions of the cell flow channels may be obstructed, or the coating solution may adhere onto the outer surface of the honeycomb substrate, which may create potential quality defects in the exhaust gas purification catalyst device.

The present invention has been completed in light of the circumstances described above. It is an object of the invention to provide a method for stably producing an exhaust gas purification catalyst device of high-quality, with reduced adhesion of coating solution onto the inner walls of the reservoir tool, even when a high-viscosity coating solution is coated onto a substrate by a suction method.

### Solution to Problem

The present invention is as follows.

### <Aspect 1>

A method for producing an exhaust gas purification catalyst device which comprises:
a substrate having a plurality of cell flow channels divided by partition walls, and
a catalyst coating layer coated inside the partition walls and/or on the partition walls of the substrate,
   the method including:
(A) placing the substrate with one open end of the plurality of cell flow channels facing upward and the other open end facing downward, and mounting a coating solution reservoir tool, having a reservoir wall extending upward from the outer periphery of the top edge of the substrate, at the upper end of the substrate, to form a coating solution reservoir defined by the upper end face of the substrate and the inner side of the reservoir wall of the coating solution reservoir tool;
(B) supplying the catalyst coating layer-forming coating solution to the coating solution reservoir;
(C) lowering the pressure in the cell flow channels below the pressure of the coating solution reservoir to introduce the catalyst coating layer-forming coating solution in the coating solution reservoir into the cell flow channels, thereby coating the catalyst coating layer-forming coating solution onto the partition walls;
(D) blasting compressed air from above onto the inner sides of the reservoir wall of the coating solution reservoir tool, and
(E) firing the substrate that has been coated with the catalyst coating layer-forming coating solution,
   and at least part of step (C) and at least part of step (D) are carried out simultaneously.

### <Aspect 2>

The method according to aspect 1, wherein step (D) is initiated after step (C) has been initiated.

### <Aspect 3>

The method according to aspect 1 or 2, wherein step (C) is completed after step (D) has been completed.

### <Aspect 4>

The method according to any one of aspects 1 to 3, wherein the reservoir wall of the coating solution reservoir tool has a vertical part that extends upward in an approximately vertical manner from the outer periphery of the upper end of the substrate, and an inclined part that extends outward and upward from the top edge of the vertical part.

### <Aspect 5>

The method according to aspect 4, wherein in step (D), the compressed air is blasted onto the inner side of the vertical part of the reservoir wall.

### <Aspect 6>

The method according to aspect 5, wherein in step (D), the angle between the blasting direction of the compressed air and the inner surface of the vertical part of the reservoir wall is 0.5° or larger and 60° or smaller.

### <Aspect 7>

The method according to any one of aspects 1 to 6, wherein in step (D), the width of the blowing hole for compressed air blasted onto the inner sides of the reservoir wall in the direction parallel to the radial direction of the substrate is 0.05 mm or greater and 1.00 mm or smaller.

### <Aspect 8>

The method according to any one of aspects 1 to 7, wherein in step (D), the pressure of the compressed air blasted onto the inner sides of the reservoir wall is 0.05 MPa or higher and 1.50 MPa or lower at the blowing hole for the compressed air.

### <Aspect 9>

The method according to any one of aspects 1 to 8, wherein the viscosity of the catalyst coating layer-forming coating solution measured at a shear rate of 0.4 s⁻¹ at 25° C. is 500 mPa·s or higher and 10,000 mPa·s or lower.

### <Aspect 10>

The method according to any one of aspects 1 to 9, wherein coating of the catalyst coating layer-forming coating solution onto the partition walls is carried out in a predetermined range downward from the top edge of the substrate.

### <Aspect 11>

The method according to any one of aspects 1 to 10, wherein after at least steps (A) to (D) have been carried out, the substrate is vertically inverted and steps (A) to (E) are then carried out.

### <Aspect 12>

The method according to any one of aspects 1 to 11, wherein the substrate is a straight flow-type honeycomb substrate.

### <Aspect 13>

The method according to any one of aspects 1 to 11, wherein the substrate is a wall flow-type honeycomb substrate.

### Advantageous Effects of Invention

According to the invention there is provided a method for stably producing an exhaust gas purification catalyst device of high-quality, with reduced adhesion of coating solution onto the inner walls of the reservoir tool, even when a high-viscosity coating solution is coated.

### BRIEF DESCRIPTION OF DRAWINGS

FIG. 1 is a simplified cross-sectional view illustrating the steps in the method for producing an exhaust gas purification catalyst device of the invention.

FIG. 2 is a set of cross-sectional photographs of a honeycomb substrate after coating. FIG. 2(a) relates to Example 1, FIG. 2(b) relates to Comparative Example 1 and FIG. 2(c) relates to Comparative Example 2.

FIG. 3 is a table showing the steps and coating results for the Examples and Comparative Examples.

### DESCRIPTION OF EMBODIMENTS

### <Method for Producing Exhaust Gas Purification Catalyst Device>

The method for producing an exhaust gas purification catalyst device of the invention is a method for producing an exhaust gas purification catalyst device which comprises:
a substrate having a plurality of cell flow channels divided by partition walls, and
a catalyst coating layer coated inside the partition walls and/or on the partition walls of the substrate,
   the method including:
(A) placing the substrate with one open end of the plurality of cell flow channels facing upward and the other open end facing downward, and mounting a coating solution reservoir tool, having a reservoir wall extending upward from the outer periphery of the top edge of the substrate, at the upper end of the substrate, to form a coating solution reservoir defined by the upper end face of the substrate and the inner side of the reservoir wall of the coating solution reservoir tool (coating solution reservoir-forming step);
(B) supplying the catalyst coating layer-forming coating solution to the coating solution reservoir (coating solution supply step);
(C) lowering the pressure in the cell flow channels below the pressure of the coating solution reservoir to introduce the catalyst coating layer-forming coating solution in the coating solution reservoir into the cell flow channels, thereby coating the catalyst coating layer-forming coating solution onto the partition walls (suction step);
(D) blasting compressed air from above onto the inner sides of the reservoir wall of the coating solution reservoir tool (blasting step), and
(E) firing the substrate that has been coated with the catalyst coating layer-forming coating solution (firing step),
   wherein at least part of step (C) and at least part of step (D) are carried out simultaneously.

In the method for producing an exhaust gas purification catalyst device of the invention, at least part of the suction step (C) and the blasting step (D) are carried out simultaneously when coating a high-viscosity coating solution onto a substrate by a suction method.

This method of the invention allows a coating solution to be coated onto a substrate to a predetermined length while inhibiting adhesion of the coating solution onto the inner walls of the reservoir tool.

If the suction step (C) is carried out first and the blasting step (D) is carried out after its completion, then adhesion of the coating solution onto the inner walls of the reservoir tool will be inhibited but the coating length of the coating solution on the outer peripheral side of the honeycomb substrate will tend to be longer than the specified value. If the blasting step (D) is carried out first, on the other hand, then when it is attempted to carry out the suction step (C) after its completion, the coating solution stored in the reservoir tool may fly out, making it difficult to coat the predetermined amount of coating solution.

By carrying out at least parts of the suction step (C) and the blasting step (D) simultaneously, the invention makes it possible to both inhibit adhesion of coating solution onto the inner walls of the reservoir tool and to coat the coating solution onto the substrate to the desired length.

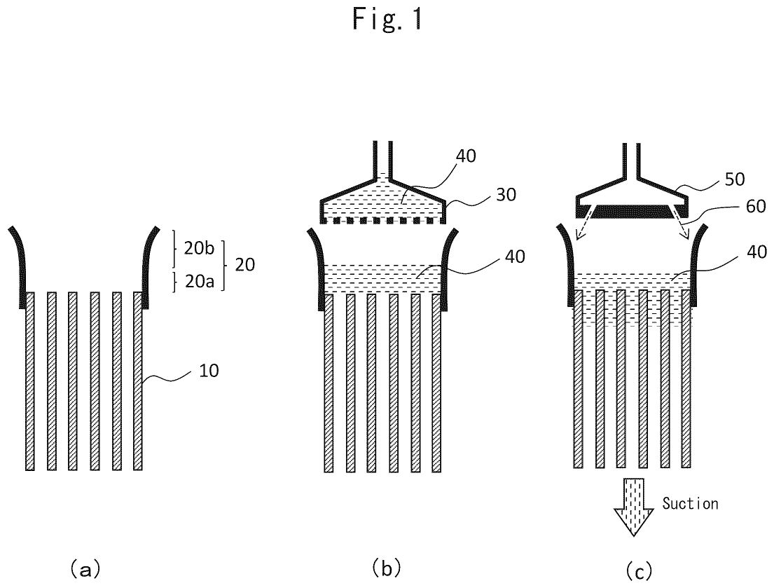

The method for producing an exhaust gas purification catalyst device of the invention will now be described with reference to the accompanying drawings. A typical example of the method for producing an exhaust gas purification catalyst device of the invention is shown in FIG. 1, as a simplified cross-sectional view.

In the method for producing an exhaust gas purification catalyst device of the invention, the substrate (10) is situated with one open end of the plurality of cell flow channels facing upward and the other open end facing downward. A coating solution reservoir tool is also mounted on the upper end of the substrate (10). The coating solution reservoir tool has a reservoir wall (20) extending upward from the outer periphery of the top edge of the substrate (10). The reservoir wall (20) may also have a vertical part (20a) extending upward in an approximately vertical manner from the outer periphery of the upper end of the substrate (10), and an inclined part (20b) extending outward and upward from the top edge of the vertical part (20a). When a coating solution reservoir tool is mounted on the substrate (10), a coating solution reservoir is formed, being defined by the upper end face of the substrate (10) and the inner side of the reservoir wall (20) of the coating solution reservoir tool (FIG. 1(a), coating solution reservoir-forming step (A)).

An appropriate shower nozzle (30) is used to supply a catalyst coating layer-forming coating solution (40) to the coating solution reservoir formed by the coating solution reservoir-forming step (A) (FIG. 1(b), coating solution supply step (B)).

In addition the following steps are carried out simultaneously:
lowering of the pressure in the cell flow channel of the substrate (10) to below the pressure of the coating solution reservoir to introduce the catalyst coating layer-forming coating solution (40) supplied to the coating solution reservoir into the cell flow channel, thus coating the catalyst coating layer-forming coating solution (40) on the partition walls of the substrate (10), and
using an appropriate compressed air feeder (50) to blast compressed air (60) from above onto the inner side of the reservoir wall (20) of the coating solution reservoir tool,
   (FIG. 1(c), suction step (C) and blasting step (D)).

The substrate (10) which has been coated with the catalyst coating layer-forming coating solution is then fired (firing step (E), not shown) to produce the exhaust gas purification catalyst device.

The substrate and catalyst coating layer of the invention will now be explained, after which each step of the method for producing the exhaust gas purification catalyst device of the invention will be described.

### <Substrate>

The substrate to be used for the invention is a substrate having a plurality of cell flow channels divided by partition walls, and it may be a honeycomb substrate used in exhaust gas purification catalyst devices of the prior art. The partition walls of the substrate may also have pores allowing fluid communication between adjacent exhaust gas flow paths.

The constituent material of the substrate may be a fire resistant inorganic oxide such as cordierite, for example. The substrate may be either a straight flow type or a wall flow type.

The substrate for the method for producing an exhaust gas purification catalyst device of the invention may typically be a cordierite straight flow type monolith honeycomb substrate or cordierite wall flow type monolith honeycomb substrate, for example.

### <Catalyst Coating Layer>

The catalyst coating layer formed by the method for producing an exhaust gas purification catalyst device of the invention is formed either or both on the partition walls or in the partition walls of the substrate.

The catalyst coating layer includes at least inorganic oxide particles, and may also include other optional components such as noble metal catalyst particles and a binder.

The catalyst coating layer may be the same as a catalyst coating layer in an exhaust gas purification catalyst device of the prior art, or it may have a different novel structure.

The method of the invention facilitates coating of a coating solution onto a substrate to a desired length. The effect of the invention is therefore advantageously exhibited if the coating form is “zone coating”, wherein the catalyst coating layer extends from the open end at one side of the substrate to a predetermined length in the lengthwise direction of the substrate.

<Coating Solution Reservoir-Forming Step (a)>

In the coating solution reservoir-forming step, first the substrate is situated with one open end of the plurality of cell flow channels facing upward and the other open end facing downward. The substrate may also be disposed so that its lengthwise direction essentially aligns with the vertical direction.

The coating solution reservoir tool is then mounted on the upper end of the substrate to form a coating solution reservoir.

The coating solution reservoir tool may have an approximately tubular shape. At least one end of the tube has a shape and size enclosing the upper end of the substrate, so that the coating solution does not leak out from gaps between the outer perimeter edge of the substrate and the inner surface of the coating solution reservoir tool.

The top of the tube of the coating solution reservoir tool (the part other than the part contacting with the upper end of the substrate) forms the reservoir wall extending upward from the outer periphery of the top edge of the substrate, while being mounted on the substrate. When a coating solution reservoir tool is mounted on the substrate, therefore, a coating solution reservoir is formed, being defined by the upper end face of the substrate and the inner sides of the reservoir wall of the coating solution reservoir tool.

The reservoir wall of the coating solution reservoir tool may also have a vertical part that extends upward in an approximately vertical manner from the outer periphery of the upper end of the substrate, and an inclined part that extends outward and upward from the top edge of the vertical part.

The lengths of the vertical part and inclined part and the length of the reservoir wall, which is their total, may be set as appropriate according to the amount of coating solution supplied to the coating solution reservoir in the coating solution supply step (B).

The structural material of the coating solution reservoir tool may be a material that can be easily attached to and removed from the upper end of the substrate, that has enough softness and pliability to avoid damage to the substrate during attachment and removal, and that is resistant to adhesion by the coating solution. Examples for structural materials of the coating solution reservoir tool include synthetic resins, and especially polyolefin resins, polyester resins, acrylic resins, polyurethane resins, ABS resins, polyimide resins and fluorine resins.

### <Coating Solution Supply Step (B)>

In the coating solution supply step (B), the catalyst coating layer-forming coating solution is supplied to the coating solution reservoir.

The catalyst coating layer-forming coating solution is a liquid composition containing the constituent components of the catalyst coating layer, or their precursors. The catalyst coating layer-forming coating solution may be a slurry containing inorganic oxide particles and water, for example, and it may also include optional components such as a precursor for noble metal catalyst particles, a binder or its precursor, and a thickener.

The viscosity of the catalyst coating layer-forming coating solution may be relatively high. The catalyst coating layer-forming coating solution may have the following viscosity values when measured at 25° C. with a shear rate of 0.4 s⁻¹ and 400 s⁻¹.

Viscosity with shear rate of 0.4 s⁻¹: 500 mPa·s or higher, 1,000 mPa·s or higher, 1,500 mPa·s or higher, 2,000 mPa·s or higher, 2,500 mPa·s or higher, 3,000 mPa·s or higher or 3,500 mPa·s or higher, and 10,000 mPa·s or lower, 8,000 mPa·s or lower, 7,000 mPa·s or lower, 6,000 mPa·s or lower or 5,000 mPa·s or lower.

Viscosity with shear rate of 400 s⁻¹: 50 mPa·s or higher, 60 mPa·s or higher, 80 mPa·s or higher, 100 mPa·s or higher, 120 mPa·s or higher or 140 mPa·s or higher, and 500 mPa·s or lower, 400 mPa·s or lower, 300 mPa·s or lower or 200 mPa·s or lower.

The feed rate of the catalyst coating layer-forming coating solution to the coating solution reservoir may be set as appropriate for the desired coating length of the catalyst coating layer. The catalyst coating layer-forming coating solution is preferably supplied to as uniform a thickness as possible over the entire surface of the upper end face of the substrate. The catalyst coating layer-forming coating solution may therefore be supplied to the coating solution reservoir using a suitable shower nozzle, for example.

Another preferred mode of the invention is to supply the catalyst coating layer-forming coating solution to the coating solution reservoir, allow a predetermined period of time to pass, and then to begin the subsequent suction step (C).

### <Suction Step (C)>

In the suction step (C), the pressure in the cell flow channel of the substrate is lowered below the pressure of the coating solution reservoir to introduce the catalyst coating layer-forming coating solution in the coating solution reservoir into the cell flow channels, thus coating the partition walls with the catalyst coating layer-forming coating solution.

Here, the pressure difference between the coating solution reservoir and the cell flow channels is used as driving force to generate an airflow in the cell flow channels whereby the catalyst coating layer-forming coating solution is introduced into the cell flow channels. However appropriately setting the viscosity and amount of catalyst coating layer-forming coating solution supplied in the coating solution supply step (B), as well as the pressure difference, results in the catalyst coating layer-forming coating solution being coated to the desired length downward from the upper end of the substrate.

The degree of pressure difference may be set so that the wind speed on the upper end face of the substrate is 10 m/sec or higher, 20 m/sec or higher, 30 m/sec or higher or 35 m/sec or higher, and 120 m/sec or lower, 100 m/sec or lower, 80 m/sec or lower, 60 m/sec or lower or 50 m/sec or lower.

The operation time for suction step (C) may be 1.0 second or longer, 1.5 seconds or longer, 2.0 seconds or longer, 2.5 seconds or longer or 3.0 seconds or longer, and 10 seconds or less, 8.0 seconds or less, 6.0 seconds or less, 5.0 seconds or less, 4.0 seconds or less or 3.0 seconds or less, from the viewpoint of reliably and efficiently accomplishing introduction of the catalyst coating layer-forming coating solution into the cell flow channel.

### <Blasting Step (D)>

In the blasting step (D), compressed air is blasted from above onto the inner sides of the reservoir wall of the coating solution reservoir tool. Thus, even if part of the catalyst coating layer-forming coating solution has adhered onto the inner sides of the reservoir wall, it is blown away and falls into the cell flow channels, forming the predetermined amount of coating of the catalyst coating layer-forming coating solution.

The compressed air may be blasted toward the inner sides of the reservoir wall using an appropriate compressed air feeder. In order to efficiently and reliably blow away the catalyst coating layer-forming coating solution adhering to the inner sides of the reservoir wall, the compressed air feeder may have a toric blowing hole with the compressed air being blown out through the blowing hole.

The width of the blowing hole of the compressed air feeder in the direction parallel to the radial direction of the substrate (preferably the ring width) is 0.05 mm or larger, 0.07 mm or larger, 0.10 mm or larger, 0.30 mm or larger, 0.40 mm or larger or 0.50 mm or larger, and 1.00 mm or smaller, 0.80 mm or smaller, 0.70 mm or smaller or 0.60 mm or smaller.

From the viewpoint of reliably causing the adhered catalyst coating layer-forming coating solution to fall into the cell flow channels, the compressed air may be blasted into the inner vertical part of the reservoir wall. In this case the angle between the blasting direction of the compressed air and the inner surface of the vertical part of the reservoir wall may be 0.5° or larger, 1.0° or larger, 5.0° or larger, 10° or larger, 15° or larger, 20° or larger or 25° or larger, and 60° or smaller, 50° or smaller, 45° or smaller, 40° or smaller or 35° or smaller.

The pressure of the compressed air blasted onto the inner sides of the reservoir wall may be 0.05 MPa or higher, 0.10 MPa or higher, 0.30 MPa or higher, 0.50 MPa or higher, 0.75 MPa or higher or 1.00 MPa or higher, and 1.50 MPa or lower, 1.25 MPa or lower, 1.00 MPa or lower or 0.80 MPa or lower, at the blowing hole of the compressed air.

### <Firing Step (E)>

In the firing step (E), the substrate that has been coated with the catalyst coating layer-forming coating solution is fired.

Firing in the firing step (E) may be carried out by a publicly known method, either directly or with appropriate changes by a person skilled in the art, depending on the composition of the catalyst coating layer-forming coating solution that is used.

### <Embodiment of Suction Step (C) and Blasting Step (D)>

It is a feature of the method for producing an exhaust gas purification catalyst device of the invention that at least part of the suction step (C) and at least part of the blasting step (D) are carried out simultaneously.

According to one embodiment of the invention, the blasting step (D) is carried out after the suction step (C) has been initiated. In this case, the time after initiation of the suction step (C) until the blasting step (D) is initiated may be 0.1 seconds or longer, 0.2 seconds or longer, 0.3 seconds or longer, 0.4 seconds or longer or 0.5 seconds or longer, and 1.0 seconds or less, 0.8 seconds or less, 0.7 seconds or less, 0.6 seconds or less or 0.5 seconds or less.

According to one embodiment of the invention, the suction step (C) is completed after the blasting step (D) has been completed. In this case, the time after completion of the blasting step (D) until the suction step (C) is completed may be 0.1 seconds or longer, 0.2 seconds or longer, 0.3 seconds or longer, 0.4 seconds or longer or 0.5 seconds or longer, and 1.0 seconds or less, 0.8 seconds or less, 0.7 seconds or less, 0.6 seconds or less or 0.5 seconds or less.

According to one embodiment of the invention, the blasting step (D) is initiated after the suction step (C) has been initiated and the suction step (C) is completed after the blasting step (D) has been completed.

### <Application of Method for Producing Exhaust Gas Purification Catalyst Device of the Invention>

The method of the invention facilitates coating of a catalyst coating layer-forming coating solution onto a substrate to a desired length. Coating of the catalyst coating layer-forming coating solution may therefore be carried out within a predetermined range downward from the top edge of the substrate. It is thereby possible to easily and precisely obtain a coating form known as “zone coating”, wherein the catalyst coating layer extends from the open end at one side of the substrate to a predetermined length in the lengthwise direction of the substrate.

After at least the coating solution reservoir-forming step (A), the catalyst coating layer-forming coating solution supply step (B), the suction step (C) and the blasting step (D) have been carried out,
the substrate may be vertically inverted, and
the coating solution reservoir-forming step (A), the catalyst coating layer-forming coating solution supply step (B), the suction step (C), the blasting step (D) and the firing step (E) may be carried out.

After at least the coating solution reservoir-forming step (A), the catalyst coating layer-forming coating solution supply step (B), the suction step (C), the blasting step (D) and the firing step (E) have been carried out,
the substrate may be vertically inverted, and
the coating solution reservoir-forming step (A), the catalyst coating layer-forming coating solution supply step (B), the suction step (C), the blasting step (D) and the firing step (E) may be carried out, again.

According to this embodiment, if the substrate is a straight flow type, then it is possible to obtain a “zone coat” catalyst coating layer in which the composition of the catalyst coating layer differs on the substrate upstream and downstream in the exhaust gas flow.

If the substrate is a wall flow type, then it is possible to form a catalyst coating layer in both the inlet side cells and the outlet side cells of the substrate.

### EXAMPLES

### Example 1

For Example 1, a coating solution was coated onto a honeycomb substrate by the method illustrated in FIGS. 1(a) to (c).

First, a circular columnar straight flow type cordierite honeycomb substrate (10) having a diameter of 100 mm and a length of 70 mm was set with its axial direction vertical.

A polyethylene coating solution reservoir tool was mounted on the upper end of the honeycomb substrate (10). The coating solution reservoir tool has an approximately cylindrical shape, and has its bottom firmly attached onto the upper end of the honeycomb substrate (10), while its top has a reservoir wall extending upward from the outer periphery of the top edge of the honeycomb substrate (10). The reservoir wall of the coating solution reservoir tool also has a vertical part (20a) extending upward in an approximately vertical manner from the outer periphery of the upper end of the honeycomb substrate (10), and an inclined part (20b) extending outward and upward from the top edge of the vertical part (20a) (FIG. 1(a)).

A shower nozzle (30) situated above the honeycomb substrate (10) was then used to supply a predetermined amount of catalyst coating layer-forming coating solution (40) into the coating solution reservoir formed by the upper end face of the honeycomb substrate (10) and the reservoir wall of the coating solution reservoir tool (FIG. 1(b)). The catalyst coating layer-forming coating solution (40) included inorganic oxide particles, and when a cone and plate viscometer was used for measurement at 25° C., the viscosity measured at a shear rate of 0.4 s⁻¹ was 4,000 mPa·s and the viscosity measured at a shear rate of 400 s⁻¹ was 150 mPa·s.

The shower nozzle (30) was then removed from above the honeycomb substrate (10) and a compressed air feeder (50) was situated in its place. The compressed air feeder (50) allowed blasting of compressed air in the shape of a torus with a width of 0.5 mm onto the inner sides of the reservoir wall of the coating solution reservoir tool, from above at an angle of 30° with respect to the vertical direction.

Suction was then carried out for 3.0 seconds from the lower end face of the honeycomb substrate (10). The suction was carried out at a strength for a wind speed of 40 m/sec on the upper end face of the honeycomb substrate (10). During this time, air blowing was carried out by blasting compressed air at 0.10 MPa using a compressed air feeder (50), for a period of 2.0 seconds, from 0.5 seconds to 2.5 seconds after the start of suction (FIG. 1(c)).

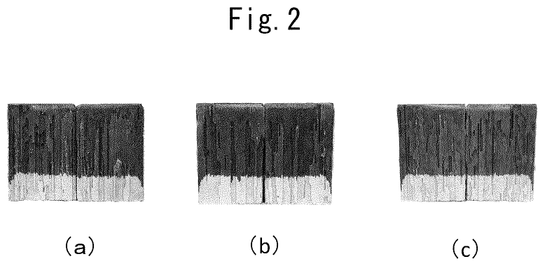

The procedure resulted in coating of the honeycomb substrate with the catalyst coating layer-forming coating solution. A cross section of the coated honeycomb substrate cut in the radial direction was observed and the coating length uniformity was examined. FIG. 2(a) shows a cross-sectional photograph taken after coating of the honeycomb substrate of Example 1.

With coating of the catalyst coating layer-forming coating solution in Example 1, no adhesion of coating solution on the coating solution reservoir tool was seen, and the entire amount of catalyst coating layer-forming coating solution supplied to the coating solution reservoir was coated on the honeycomb substrate. As shown in FIG. 2(a), the coating length of the catalyst coating layer-forming coating solution was longest near the outer periphery of the substrate, first decreasing and subsequently increasing slightly from the outer periphery toward the center. The difference between the maximum length and minimum length of the coating length was 11.0 mm.

### Comparative Example 1

For Comparative Example 1, the catalyst coating layer-forming coating solution was coated onto the honeycomb substrate and evaluated in the same manner as Example 1, except that after the catalyst coating layer-forming coating solution was supplied into the coating solution reservoir on top of the honeycomb substrate, suction was carried out for 3.0 seconds and air blowing was carried out for 2.0 seconds, in that order.

FIG. 2(b) shows a cross-sectional photograph taken after coating of the honeycomb substrate of Comparative Example 1.

With coating of the catalyst coating layer-forming coating solution in Comparative Example 1, no adhesion of coating solution on the coating solution reservoir tool was seen, and the entire amount of catalyst coating layer-forming coating solution supplied to the coating solution reservoir was coated on the honeycomb substrate. However, the difference between the maximum and minimum coating length of the catalyst coating layer was 16.0 mm.

### Comparative Example 2

For Comparative Example 2, the catalyst coating layer-forming coating solution was coated onto the honeycomb substrate and evaluated in the same manner as Example 1, except that after the catalyst coating layer-forming coating solution was supplied into the coating solution reservoir on top of the honeycomb substrate, suction was carried out for 3.0 seconds, air blowing was carried out for 2.0 seconds and suction was carried out for 3.0 seconds, in that order.

FIG. 2(c) Shows a cross-sectional photograph taken after coating of the honeycomb substrate of Comparative Example 2.

With coating of the catalyst coating layer-forming coating solution in Comparative Example 2, there was no visible adhesion of coating solution onto the coating solution reservoir tool.

However, part of the catalyst coating layer-forming coating solution supplied to the coating solution reservoir had flowed out from the lower end face of the honeycomb substrate. The difference between the maximum and minimum coating length of the catalyst coating layer was 16.5 mm.

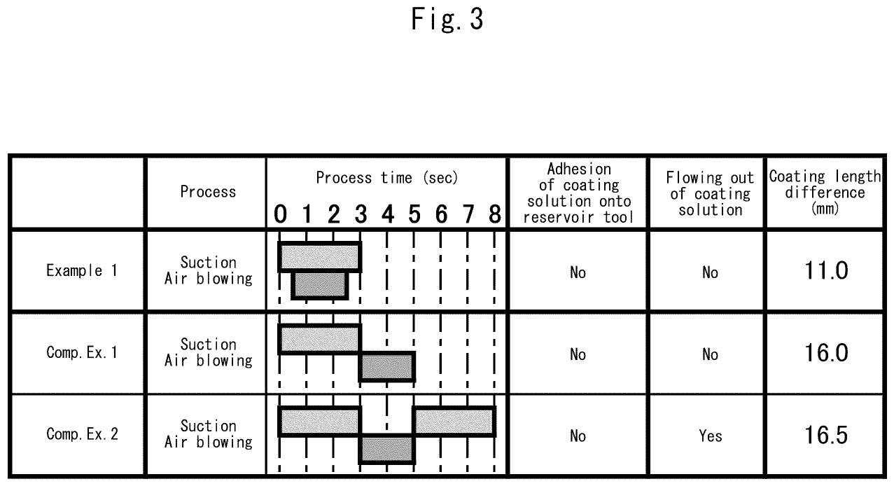

The results are summarized in Table 1 (FIG. 3).

### REFERENCE SIGNS LIST

10 Honeycomb substrate
20 Reservoir wall
20a Vertical part
20b Inclined part
30 Shower nozzle
40 Catalyst coating layer-forming coating solution
50 Compressed air feeder
60 Compressed air

1. A method for producing an exhaust gas purification catalyst device which comprises:
a substrate having a plurality of cell flow channels divided by partition walls, and
a catalyst coating layer coated inside the partition walls and/or on the partition walls of the substrate,
the method including:
(A) placing the substrate with one open end of the plurality of cell flow channels facing upward and the other open end facing downward, and mounting a coating solution reservoir tool, having a reservoir wall extending upward from the outer periphery of the top edge of the substrate, at the upper end of the substrate, to form a coating solution reservoir defined by the upper end face of the substrate and the inner side of the reservoir wall of the coating solution reservoir tool;
(B) supplying the catalyst coating layer-forming coating solution to the coating solution reservoir;
(C) lowering the pressure in the cell flow channels below the pressure of the coating solution reservoir to introduce the catalyst coating layer-forming coating solution in the coating solution reservoir into the cell flow channels, thereby coating the catalyst coating layer-forming coating solution onto the partition walls;
(D) blasting compressed air from above onto the inner sides of the reservoir wall of the coating solution reservoir tool, and
(E) firing the substrate that has been coated with the catalyst coating layer-forming coating solution,
and at least part of step (C) and at least part of step (D) are carried out simultaneously.

2. The method according to claim 1, wherein step (D) is initiated after step (C) has been initiated.

3. The method according to claim 1, wherein step (C) is completed after step (D) has been completed.

4. The method according to claim 2, wherein step (C) is completed after step (D) has been completed.

5. The method according to claim 1, wherein the reservoir wall of the coating solution reservoir tool has a vertical part that extends upward in an approximately vertical manner from the outer periphery of the upper end of the substrate, and an inclined part that extends outward and upward from the top edge of the vertical part.

6. The method according to claim 5, wherein in step (D), the compressed air is blasted onto the inner side of the vertical part of the reservoir wall.

7. The method according to claim 6, wherein in step (D), the angle between the blasting direction of the compressed air and the inner surface of the vertical part of the reservoir wall is 0.5° or larger and 60° or smaller.

8. The method according to claim 1, wherein in step (D), the width of the blowing hole for compressed air blasted onto the inner sides of the reservoir wall in the direction parallel to the radial direction of the substrate is 0.05 mm or greater and 1.00 mm or smaller.

9. The method according to claim 1, wherein in step (D), the pressure of the compressed air blasted onto the inner sides of the reservoir wall is 0.05 MPa or higher and 1.50 MPa or lower at the blowing hole for the compressed air.

10. The method according to claim 1, wherein the viscosity of the catalyst coating layer-forming coating solution measured at a shear rate of 0.4 s⁻¹ at 25° C. is 500 mPa·s or higher and 10,000 mPa·s or lower.

11. The method according to claim 1, wherein coating of the catalyst coating layer-forming coating solution onto the partition walls is carried out in a predetermined range downward from the top edge of the substrate.

12. The method according to claim 1, wherein after at least steps (A) to (D) have been carried out, the substrate is vertically inverted and steps (A) to (E) are then carried out.

13. The method according to claim 1, wherein the substrate is a straight flow-type honeycomb substrate.

14. The method according to claim 1, wherein the substrate is a wall flow-type honeycomb substrate.
